(19) United States
(12) Patent Application Publication
(10) Pub. No.: US 2023/0153851 A1
(43) Pub. Date: May 18, 2023

(54) VEHICLE ASSESSMENT METHOD AND STORAGE MEDIUM

(71) Applicant: TOYOTA JIDOSHA KABUSHIKI KAISHA, Toyota-shi Aichi-ken (JP)

(72) Inventors: Yohei Ogawa, Toyota-shi Aichi-ken (JP); Jun Tahara, Toyota-shi Aichi-ken (JP)

(73) Assignee: TOYOTA JIDOSHA KABUSHIKI KAISHA, Toyota-shi Aichi-ken (JP)

(21) Appl. No.: 17/945,681

(22) Filed: Sep. 15, 2022

(30) Foreign Application Priority Data
Nov. 15, 2021 (JP) 2021-185651

(51) Int. Cl. G06Q 30/02

(52) U.S. Cl. CPC G06Q 30/0206; G06Q 30/0283; G06Q 30/0278

(57) ABSTRACT

Vehicle information on a target vehicle and market information on resale prices or assessed prices of same-type vehicles are acquired. Which one of an average vehicle, a point-addition vehicle, and a point-deduction vehicle corresponds to the target vehicle is determined, and an average assessed price of the same-type vehicles in a distance range is specified. When the target vehicle is the average vehicle, the average assessed price of the same-type vehicles is set as an assessed value for the target vehicle. When the target vehicle is the point-addition vehicle, a price higher than the average assessed price of the same-type vehicles is set as the assessed value. When the target vehicle is the point-deduction vehicle, a price lower than the average assessed price of the same-type vehicles is set as the assessed value. The set assessed price of the target vehicle is output.

### CROSS-REFERENCE TO RELATED APPLICATION

This application claims priority to Japanese Patent Application No. 2021-185651 filed on Nov. 15, 2021, incorporated herein by reference in its entirety.

### BACKGROUND

### 1. Technical Field

The present disclosure relates to a vehicle assessment method and a storage medium.

### 2. Description of Related Art

In the related art, as a vehicle price assessment method for calculating an appropriate market price of a vehicle by evaluating a vehicle state of the vehicle, a vehicle market supply-demand situation, and so on, there has been proposed a technology including vehicle data collecting means for measuring a vehicle state of a vehicle so as to accumulate the vehicle state in the vehicle or send the vehicle state to the vehicle, and assessment basic data generating means for analyzing vehicle data and generating assessment basic data based on which the vehicle state is assessed (e.g., see Japanese Unexamined Patent Application Publication No. 2006-107409 (JP 2006-107409 A)).

### SUMMARY

The assessed price (trade-in price) or the resale price of a vehicle is often set based on a travel distance of the vehicle. However, even with the same travel distance, the assessed price or the resale price varies depending on the usage of the vehicle, or the like. Accordingly, how the assessed price of a target vehicle is set based on its travel distance remains a problem.

A main object of a vehicle assessment method and a storage medium of the present disclosure is to set the assessed price of a target vehicle more appropriately.

In order to achieve the main object, the vehicle assessment method and the storage medium of the present disclosure employ the following approaches.

A vehicle assessment method of the present disclosure is a vehicle assessment method for assessing a target vehicle. The vehicle assessment method includes: (A) a step of acquiring vehicle information on the target vehicle, the vehicle information including a travel distance of the target vehicle, and market information on resale prices or assessed prices of same-type vehicles as vehicles of the same vehicle type as the target vehicle; (B) a step of determining, based on the vehicle information, which one of an average vehicle, a point-addition vehicle, and a point-deduction vehicle corresponds to the target vehicle and specifying, based on the market information on the same-type vehicles, an average assessed price of the same-type vehicles in a distance range to which the travel distance of the target vehicle belongs; (C) a step of setting the average assessed price of the same-type vehicles as an assessed price for the target vehicle when the target vehicle is the average vehicle, setting a price higher than the average assessed price of the same-type vehicles as the assessed price for the target vehicle when the target vehicle is the point-addition vehicle, and setting a price lower than the average assessed price of the same-type vehicles as the assessed price for the target vehicle when the target vehicle is the point-deduction vehicle; and (D) a step of outputting the assessed price of the target vehicle.

In the vehicle assessment method of the present disclosure, first, the vehicle information on the target vehicle, the vehicle information including the travel distance of the target vehicle, and the market information on resale prices or assessed prices of same-type vehicles as vehicles of the same vehicle type as the target vehicle are acquired. Subsequently, which one of the average vehicle, the point-addition vehicle, and the point-deduction vehicle corresponds to the target vehicle is determined based on the vehicle information on the target vehicle, and the average assessed price of the same-type vehicles in the distance range to which the travel distance of the target vehicle belongs is specified based on the market information on the same-type vehicles. When the target vehicle is the average vehicle, the average assessed price of the same-type vehicles is set as the assessed value for the target vehicle. When the target vehicle is the point-addition vehicle, a price higher than the average assessed price of the same-type vehicles is set as the assessed value for the target vehicle. When the target vehicle is the point-deduction vehicle, a price lower than the average assessed price of the same-type vehicles is set as the assessed value for the target vehicle. The set assessed price of the target vehicle is output. That is, the assessed value of the target vehicle is set based on which one of the average vehicle, the point-addition vehicle, and the point-deduction vehicle corresponds to the target vehicle and the average assessed price of the same-type vehicles in the distance range to which the travel distance of the target vehicle belongs. Hereby, it is possible to set the assessed price of the target vehicle more appropriately. Further, the user can grasp the assessed price of the target vehicle. Here, the “average vehicle,” the “point-addition vehicle,” and the “point-deduction vehicle” are evaluated as a normal (average) vehicle, a vehicle better than normal, and a vehicle poorer than normal, respectively, by generally determining the usage of the target vehicle and the aging state of each part of the target vehicle in the distance range to which the target vehicle belongs.

In the vehicle assessment method of the present disclosure, in the step (B), which one of the average vehicle, the point-addition vehicle, and the point-deduction vehicle corresponds to the target vehicle may be determined based on at least one of a frequency of use of the target vehicle, a maintenance history of the target vehicle, an unwarmed operation state of an engine of the target vehicle, an idling time of the engine of the target vehicle, the number of times that an absolute value of acceleration of the target vehicle becomes larger than an acceleration threshold, the number of times of stationary steering of a steering wheel of the target vehicle, the number of times of parking of the target vehicle in sloped areas, the number of times of a shift operation of the target vehicle in a direction reverse to an advancing direction of the target vehicle, the number of times of the shift operation of the target vehicle with a steering-wheel operation, a use temperature history of a power storage device of the target vehicle, and an aging state of each part of the target vehicle. Hereby, it is possible to more appropriately determine which one of the average vehicle, the point-addition vehicle, and the point-deduction vehicle corresponds to the target vehicle.

In the vehicle assessment method of the present disclosure, in the step (A), upon receipt of a request of assessment of the target vehicle, the vehicle information on the target vehicle and the market information on the same-type vehicles may be acquired. With this configuration, it is possible to set the assessed price of the target vehicle by use of the latest or relatively new vehicle information on the target vehicle and the latest or relatively new market information on the same-type vehicles.

The vehicle assessment method of the present disclosure may further include (E) a step of, based on the market information, setting a future assessed price range of the target vehicle. In the step (D), in addition to the assessed price of the target vehicle, the future assessed price range and an upper limit of the future assessed price range may be output, or the future assessed price range or the upper limit of the future assessed price range may be output. Hereby, the user can also grasp the future assessed price range and its upper limit in addition to the assessed price of the target vehicle. In this case, the vehicle assessment method of the present disclosure may further include (F) a step of providing an advice such that a future assessed price of the target vehicle approaches the upper limit of the future assessed price range. With this configuration, the user can consider the content of the advice.

The vehicle assessment method of the present disclosure may further include (F) a step of providing an advice such that the target vehicle is maintained to be the point-addition vehicle in future or the target vehicle turns from the average vehicle or the point-deduction vehicle to the point-addition vehicle. With this configuration, the user can consider the content of the advice.

A storage medium of the present disclosure is a storage medium storing a program causing one or more computers to execute each of the steps of the vehicle assessment method according to any one of the above aspects of the present disclosure. That is, the vehicle assessment method is basically a vehicle assessment method for assessing a target vehicle, and the vehicle assessment method includes: (A) a step of acquiring vehicle information on the target vehicle, the vehicle information including a travel distance of the target vehicle, and market information on resale prices or assessed prices of same-type vehicles as vehicles of the same vehicle type as the target vehicle; (B) a step of determining, based on the vehicle information, which one of an average vehicle, a point-addition vehicle, and a point-deduction vehicle corresponds to the target vehicle and specifying, based on the market information on the same-type vehicles, an average assessed price of the same-type vehicles in a distance range to which the travel distance of the target vehicle belongs; (C) a step of setting the average assessed price of the same-type vehicles as an assessed price for the target vehicle when the target vehicle is the average vehicle, setting a price higher than the average assessed price of the same-type vehicles as the assessed price for the target vehicle when the target vehicle is the point-addition vehicle, and setting a price lower than the average assessed price of the same-type vehicles as the assessed price for the target vehicle when the target vehicle is the point-deduction vehicle; and (D) a step of outputting the assessed price of the target vehicle.

The program stored in the storage medium of the present disclosure causes one or more computers to execute each of the steps of the vehicle assessment method according to any one of the above aspects of the present disclosure. Hereby, it is possible to yield an effect similar to the effect obtained by the vehicle assessment method of the present disclosure, e.g., the effect that the assessed price of the target vehicle can be set more appropriately.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a configuration diagram illustrating an outline of a configuration of a server 20 configured to assess a vehicle 30 by a vehicle assessment method as one embodiment of the present disclosure;

FIG. 2 is an explanatory view illustrating an example of the relationship between travel distance, resale price, and the number of vehicles in terms of a given vehicle type;

FIG. 3 is a flowchart illustrating an example of a vehicle assessment program 22 to be executed by the server 20;

FIG. 4 is an explanatory view illustrating an example of the number of vehicles per price range and the average resale price in terms of same-type vehicles in a distance range to which the vehicle 30 belongs; and

FIG. 5 is an explanatory view illustrating examples of a present assessed price of the vehicle 30, present and future assessed price ranges of the vehicle 30, and so on.

### DETAILED DESCRIPTION OF EMBODIMENTS

Next will be described a mode for carrying out the disclosure with reference to an embodiment.

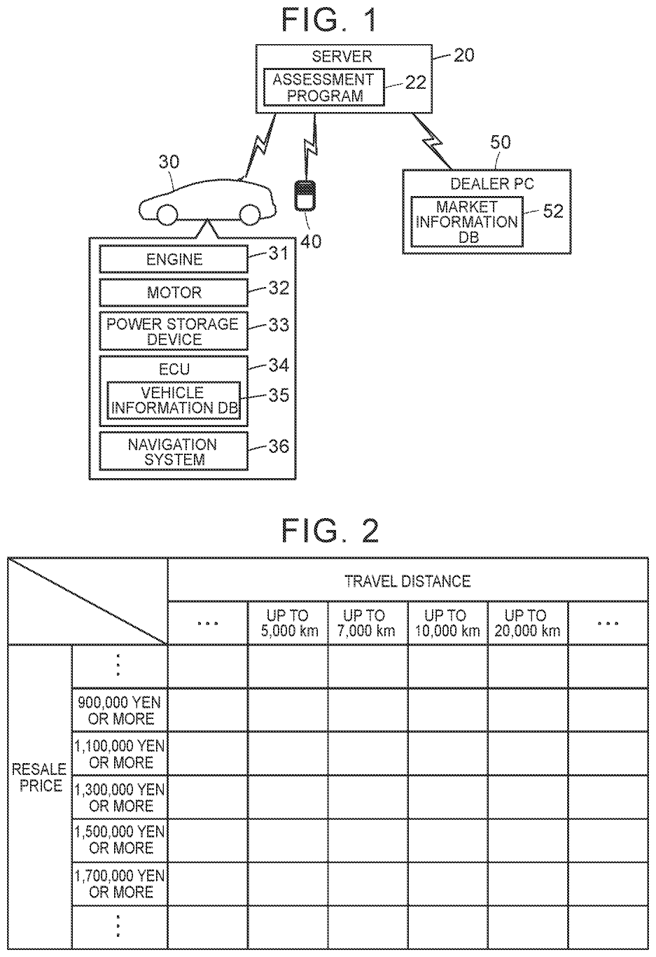

FIG. 1 is a configuration diagram illustrating an outline of a configuration of a server 20 configured to assess a vehicle 30 (a target vehicle) by a vehicle assessment method as one embodiment of the present disclosure. The server 20 is configured as a well-known computer and includes a CPU, a ROM, a RAM, a flash memory, a storage device (e.g., an HDD, an SSD, or the like), an input-output port, a communications port, and so on. A vehicle assessment program 22 or the like by which the vehicle 30 is assessed is installed in the server 20. The server 20 is an example of a storage medium. The server 20 is communicable with the vehicle 30, a portable terminal 40, and a dealer PC 50 as a computer provided in a used vehicle dealer, in a wired or wireless manner.

The vehicle 30 is configured as a hybrid electric vehicle of a series type or a parallel type. The vehicle 30 includes an engine 31, a motor 32, a driving power storage device 33 configured to exchange electric power with the motor 32, an electronic control unit (hereinafter referred to as “ECU”) 34 configured to control the engine 31 and the motor 32 and manage the driving power storage device 33, a navigation system 36, and so on. Note that, instead of the hybrid electric vehicle, the vehicle 30 may be an engine vehicle that does not include the motor 32 and the driving power storage device 33, a battery electric vehicle that does not include the engine 31, a fuel cell electric vehicle including a fuel cell without the engine 31, or the like.

The ECU 34 is configured as a well-known microcomputer and includes a CPU, a ROM, a RAM, a flash memory, an input-output port, a communications port, and so on. In the flash memory of the ECU 34, a vehicle information database 35 on the vehicle 30 is stored. The vehicle information database 35 includes, for example, a travel distance of the vehicle 30, a frequency of use of the vehicle 30, a maintenance history of the vehicle 30, an unwarmed operation state of the engine 31 (a rotation number and a torque before completion of warming-up), an idling time of the engine 31, the number of times of immediate acceleration-deceleration of the vehicle 30 (the number of times that the absolute value of the acceleration of the vehicle 30 becomes larger than an acceleration threshold), the number of times of stationary steering of a steering wheel of the vehicle 30, the number of times of parking of the vehicle 30 in sloped areas, the number of times of a shift operation of the vehicle 30 in a direction reverse to its advancing direction, the number of times of a shift operation of the vehicle 30 with a steering-wheel operation, a use temperature history of the driving power storage device 33, an aging state of each part (e.g., the engine 31, the motor 32, and the driving power storage device 33) of the vehicle 30, and so on. In the vehicle information database 35, information other than information on the vehicle distance of the vehicle 30 and the aging state of each part is information per predetermined distance (e.g., about a several hundred kilometers to several thousand kilometers). The vehicle information database 35 is updated sequentially.

The navigation system 36 is configured as a system configured to guide a route to a destination set by a user and includes a well-known computer, a touch-panel-type display, and so on. The computer includes a CPU, a ROM, a RAM, a flash memory, a storage device (e.g., an HDD, an SSD, or the like), an input-output port, a communications port, and so on. Map information and so on are stored in the storage device. A first assessment requesting application or the like configured to request an assessment of the vehicle 30 (a host vehicle) is installed in the computer. Various pieces of information such as map information are display on the display. The ECU 34 and the navigation system 36 are wirelessly communicable with the server 20.

The portable terminal 40 is configured as a smartphone, a tablet terminal, or the like and includes a well-known computer, a touch-panel-type display, and so on. The computer includes a CPU, a ROM, a RAM, a flash memory, a storage device (e.g., an HDD, an SSD, or the like), an input-output port, a communications port, and so on. A second assessment requesting application or the like configured to select a desired vehicle and request an assessment of the desired vehicle is installed in the computer. Various pieces of information are displayed on the display. The portable terminal 40 is wirelessly communicable with the server 20.

The dealer PC 50 is configured as a well-known computer and includes a CPU, a ROM, a RAM, a flash memory, a storage device (e.g., an HDD, an SSD, or the like), an input-output port, a communications port, and so on. In the storage device, a market information database 52 is stored. The market information database 52 includes, for example, the relationship between travel distance, resale price, and the number of vehicles for each vehicle type, and so on. The market information database 52 is updated sequentially. FIG. 2 is an explanatory view illustrating an example of the relationship between travel distance, resale price, and the number of vehicles in terms of a given vehicle type. In FIG. 2, the travel distance is divided into a plurality of distance ranges, the price is divided into a plurality of price ranges, and the number of vehicles is associated with each range. The dealer PC 50 is communicable with the server 20 in a wired or wireless manner.

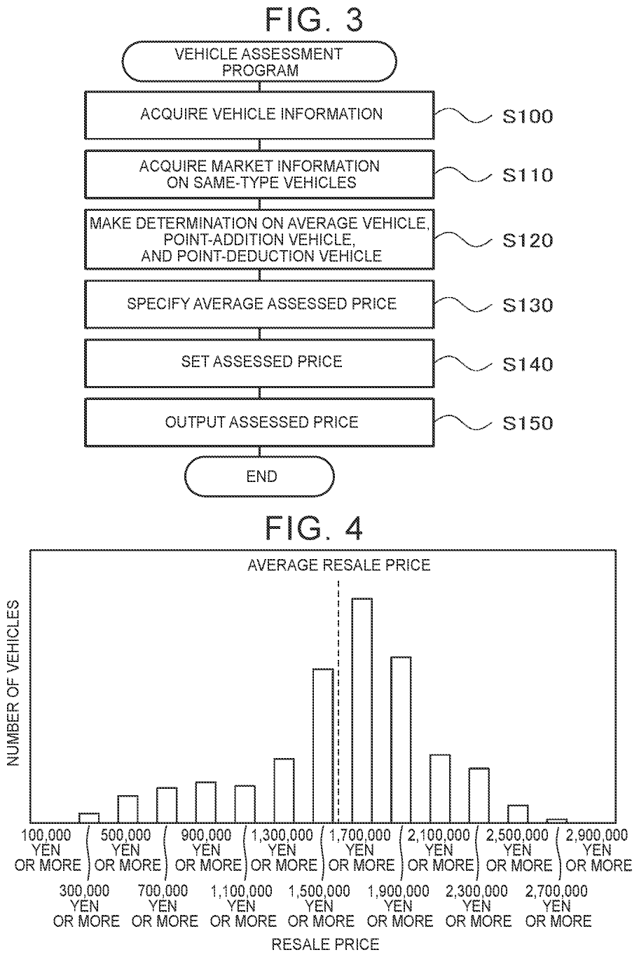

Next will be described the operation of the server 20 in the embodiment that is configured as described above. FIG. 3 is a flowchart illustrating an example of a vehicle assessment program 22 to be executed by the server 20. This program is executed when the navigation system 36 of the vehicle 30 is operated by the user to request the server 20 to assessment the vehicle 30 (a target vehicle) by the first assessment requesting application, or when the portable terminal 40 is operated such that the vehicle 30 is selected as a desired vehicle and an assessment of the vehicle 30 is requested to the server 20 by the second assessment requesting application.

When the vehicle assessment program 22 is executed, the CPU of the server 20 first acquires vehicle information from the vehicle 30 (step S100). In this process, the server 20 transmits a request of vehicle information to the vehicle 30, and the ECU 34 of the vehicle 30 that has received the request transmits at least part of the vehicle information in the vehicle information database 35 to the server 20. The vehicle information transmitted from the vehicle 30 to the server 20 includes the travel distance of the vehicle 30, the frequency of use of the vehicle 30, the maintenance history of the vehicle 30, the unwarmed operation state of the engine 31, the idling time of the engine 31, the number of times of immediate acceleration-deceleration of the vehicle 30 (the number of times that the absolute value of the acceleration of the vehicle 30 becomes larger than an acceleration threshold), the number of times of stationary steering of the steering wheel of the vehicle 30, the number of times of parking of the vehicle 30 in sloped areas, the number of times of the shift operation of the vehicle 30 in the direction reverse to its advancing direction, the number of times of the shift operation of the vehicle 30 with the steering-wheel operation, the use temperature history of the driving power storage device 33, and the aging states of the engine 31, the motor 32, and the driving power storage device 33 of the vehicle 30.

Subsequently, the server 20 acquires market information on same-type vehicles that are vehicles of the same vehicle type as the vehicle 30 from the dealer PC 50 (step S110). In this process, the server 20 transmits a request of the market information on the same-type vehicles to the dealer PC 50, and the dealer PC 50 that has received the request transmits at least part of the market information on the same-type vehicles in the market information database 52 to the server 20. The market information on the same-type vehicles that is transmitted to the server 20 from the dealer PC includes the relationship between travel distance, resale price, and the number of vehicles in terms of the same-type vehicles (see FIG. 2).

Then, the server 20 determines, based on the vehicle information on the vehicle 30, which one of an average vehicle, a point-addition vehicle, and a point-deduction vehicle corresponds to the vehicle 30 (step S120). Here, the “average vehicle,” the “point-addition vehicle,” and the “point-deduction vehicle” are evaluated as a normal (average) vehicle, a vehicle better than normal, and a vehicle poorer than normal, respectively, by generally determining the usage of the vehicle 30 and the aging state of each part of the vehicle 30 (e.g., the engine 31, the motor 32, and the driving power storage device 33) in the distance range to which the vehicle 30 belongs.

In the process of step S120, based on each field in the vehicle information on the vehicle 30, the server 20 calculates a vehicle index Iv on the usage of the vehicle 30 and the aging state of each part of the vehicle 30. When the calculated vehicle index Iv is within a normal range, the server 20 determines that the vehicle 30 is the average vehicle, when the vehicle index Iv is higher than the normal range, the server 20 determines that the vehicle 30 is the point-addition vehicle, and when the vehicle index Iv is lower than the normal range, the server 20 determines that the vehicle 30 is the point-deduction vehicle. The vehicle index Iv can be calculated by Formula (1) by use of field indices Ii[i] (i: 1 to 13) based on respective fields in the vehicle information on the vehicle 30 and weighting factors w[i].

Iv=w[1]·Ii[1]+ . . . +w[13]·Ii[13] (1)

The field index Ii[1] is an index on the frequency of use of the vehicle 30 and is set to be higher when an average interval between trips is short (the vehicle 30 is used regularly) as compared with a case where the average interval between trips is long (the vehicle 30 is left for a long time and is not used regularly). The field index Ii[2] is an index on the maintenance history of the vehicle 30. The field index Ii[2] is set to be higher when the maintenance of the vehicle 30 is performed by its authorized dealer as compared with a case where the maintenance is performed by other shops, and the field index Ii[2] is also set to be higher when the maintenance of the vehicle 30 is performed regularly (e.g., every 12 months) as compared with a case where the maintenance is not performed regularly.

The field index Ii[3] is an index on the unwarmed operation state of the engine 31. The field index Ii[3] is set to be lower as the number of times that or a period of time when the rotation number of the engine 31 becomes larger than a predetermined rotation number or the torque of the engine 31 becomes larger than a predetermined torque before completion of the warming-up of the engine 31. The field index Ii[4] is an index on the idling time of the engine 31 and is set to be lower as the idling time is longer.

The field index Ii[5] is an index on the number of times of immediate acceleration-deceleration of the vehicle 30 and is set to be lower as the number of times of immediate acceleration-deceleration is larger. The field index Ii[6] is an index on the number of times of stationary steering of the steering wheel of the vehicle 30 and is set to be lower as the number of times of stationary steering of the steering wheel is larger. The field index Ii[7] is an index on the number of times of parking of the vehicle 30 in sloped areas and is set to be lower as the number of times of parking in sloped areas is larger.

The field index Ii[8] is an index on the number of times of the shift operation of the vehicle 30 in the direction reverse to the advancing direction and is set to be lower as the number of times of the shift operation is larger. The field index Ii[9] is an index on the number of times of the shift operation of the vehicle 30 with the steering-wheel operation and is set to be lower as the number of times of the shift operation is larger.

The field index Ii[10] is an index on the use temperature history of the driving power storage device 33 and is set to be lower as the number of times that or a period of time when the temperature of the driving power storage device 33 is higher than a predetermined temperature. The field indices Ii[11], Ii[12], Ii[13] are indices on the aging states of the engine 31, the motor 32, and the driving power storage device 33 of the vehicle 30 and are set to be higher as the aging states of the engine 31, the motor 32, and the driving power storage device 33 are better (closer to new products).

Subsequently, the server 20 specifies the average assessed price of the same-type vehicles based on the market information on the same-type vehicles (step S130). In this process, the average resale price of the same-type vehicles in the distance range to which the vehicle 30 belongs is calculated based on the number of vehicles in each price range (resale price region) in terms of the same-type vehicles in the distance range to which the vehicle 30 belongs, the number of vehicles being included in the market information on the same-type vehicles. Then, an expense, a margin, and so on for a dealer, a broker, or the like are subtracted from the calculated average resale price of the same-type vehicles, so that the average assessed price of the same-type vehicles in the distance range to which the vehicle 30 belongs is calculated. The expense, the margin, and so on for the dealer, the broker, or the like are set appropriately. FIG. 4 is an explanatory view illustrating examples of the number of vehicles per price range and the average resale price in terms of the same-type vehicles in the distance range to which the vehicle 30 belongs.

The server 20 sets an assessed price for the vehicle 30 based on which one of the average vehicle, the point-addition vehicle, and the point-deduction vehicle corresponds to the vehicle 30 and the average assessed price of the same-type vehicles (step S140). In this process, when the vehicle 30 is the average vehicle, the server 20 sets the average assessed price of the same-type vehicles as the assessed price for the vehicle 30, when the vehicle 30 is the point-addition vehicle, the server 20 sets, as the assessed price for the vehicle 30, a price that is higher as the vehicle index Iv is larger within a range above the average assessed price of the same-type vehicles, and when the vehicle 30 is the point-deduction vehicle, the server 20 sets, as the assessed price for the vehicle 30, a price that is lower as the vehicle index Iv is smaller within a range below the average assessed price of the same-type vehicles.

When the assessed price of the vehicle 30 is set as such, the server 20 transmits the set assessed price of the vehicle 30 and a display instruction on the set assessed price to the navigation system 36 or the portable terminal 40 that has requested the assessment of the vehicle 30 (step S150) and the server 20 ends the routine. Upon receipt of the assessed price of the vehicle 30 and the display instruction on the set assessed price, the navigation system 36 or the portable terminal 40 displays the assessed price of the vehicle 30 on the display. Thus, the user can be notified of the assessed price of the vehicle 30. Accordingly, the user can grasp the assessed price of the vehicle 30 even when the user does not bring the vehicle 30 to a dealer, a purchase trader, or the like.

In the vehicle assessment method (the vehicle assessment program 22) to be executed by the server 20 of the embodiment described above, upon receipt of a request to assess the vehicle 30 from the navigation system 36 of the vehicle 30 or the portable terminal 40, the server 20 first acquires vehicle information on the vehicle 30 and market information on the same-type vehicles. Subsequently, the server 20 determines, based on the vehicle information, which one of the average vehicle, the point-addition vehicle, and the point-deduction vehicle corresponds to the vehicle 30, and the server 20 specifies, based on the market information on the same-type vehicles, the average assessed price of the same-type vehicles in the distance range to which the vehicle 30 belongs. Then, when the vehicle 30 is the average vehicle, the server 20 sets the average assessed price of the same-type vehicles as the assessed price for the vehicle 30, when the vehicle 30 is the point-addition vehicle, the server 20 sets a price higher than the average assessed price of the same-type vehicles as the assessed price for the vehicle 30, and when the vehicle 30 is the point-deduction vehicle, the server 20 sets a price lower than the average assessed price of the same-type vehicles as the assessed price for the vehicle 30. Then, the server 20 transmits the set assessed price of the vehicle 30 to the navigation system 36 of the vehicle 30 or the portable terminal 40. As such, the server 20 sets the assessed price for the vehicle 30 in consideration of which one of the average vehicle, the point-addition vehicle, and the point-deduction vehicle corresponds to the vehicle 30 and the average assessed price of the same-type vehicles in the distance range to which the vehicle 30 belongs. Hereby, it is possible to set the assessed price of the vehicle 30 more appropriately. Besides, when the server 20 receives a request of the assessment of the vehicle 30 from the navigation system 36 or the portable terminal 40, the server 20 acquires the vehicle information on the vehicle 30 and the market information on the same-type vehicles. Hereby, it is possible to set the assessed price of the vehicle 30 by use of the latest or relatively new vehicle information on the vehicle 30 and the latest or relatively new market information on the same-type vehicles.

In the vehicle assessment method in the embodiment, the market information database 52 is stored in the dealer PC 50. However, the market information database may be stored in the server 20.

In the vehicle assessment method in the embodiment, the server 20 acquires the market information on the same-type vehicles from the dealer PC 50. However, the server 20 may acquire the market information on the same-type vehicles from various types of websites or the like.

In the vehicle assessment method in the embodiment, the server 20 acquires, as the market information on the same-type vehicles, the relationship between travel distance, resale price, and the number of vehicles in terms of the same-type vehicles. However, the server 20 may acquire, as the market information on the same-type vehicles, the relationship between travel distance, assessed price, and the number of vehicles in terms of the same-type vehicles. In this case, the server 20 should calculate the average assessed price of the same-type vehicles in the distance range to which the vehicle 30 belongs, based on the number of vehicles in each price range (assessed price range) of the same-type vehicles in the distance range to which the vehicle 30 belongs.

In the vehicle assessment method in the embodiment and the modifications described above, the server 20 acquires, as the market information on the same-type vehicles, the relationship between travel distance, resale price or assessed price, and the number of vehicles in terms of the same-type vehicles. However, the server 20 may acquire the relationship between resale price or assessed price and the number of vehicles in terms of the same-type vehicles in the distance range to which the vehicle 30 belongs, that is, the server 20 may not acquire the relationship between resale price or assessed price and the number of vehicles in terms of the same-type vehicles in distance ranges other than the distance range to which the vehicle 30 belongs. Hereby, it is possible to reduce the amount of data (the communication traffic volume with the dealer PC 50) to be acquired.

In the vehicle assessment method in the embodiment, the server 20 calculates the vehicle index Iv by use of the field indices Ii[1] to Ii[13] based on the following fields: the frequency of use of the vehicle 30; the maintenance history of the vehicle 30; the unwarmed operation state of the engine 31; the idling time of the engine 31; the number of times of immediate acceleration-deceleration of the vehicle 30; the number of times of stationary steering of the steering wheel of the vehicle 30; the number of times of parking of the vehicle 30 in sloped areas; the number of times of the shift operation of the vehicle 30 in the direction reverse to its advancing direction; the number of times of the shift operation of the vehicle 30 with the steering-wheel operation; the use temperature history of the driving power storage device 33; and the aging states of the engine 31, the motor 32, and the driving power storage device 33 of the vehicle 30. However, the server 20 may calculate the vehicle index Iv by use of only some of the field indices Ii[1] to Ii[13]. Further, instead of some of or all of the field indices Ii[1] to Ii[13], the server 20 may calculate the vehicle index Iv by use of field indices different from them. The field indices here include, for example, a field index based on the cycle number by electric power larger than predetermined electric power of the driving power storage device 33 of the vehicle 30, and a field index based on the aging state of a power storage device for accessories, tires, an air-conditioning device (all are not illustrated herein), and so on in the vehicle 30.

In the vehicle assessment method in the embodiment, when the vehicle 30 is the point-addition vehicle, the server 20 sets, as the assessed price for the vehicle 30, a price that is higher as the vehicle index Iv is larger within a range above the average assessed price of the same-type vehicles, and when the vehicle 30 is the point-deduction vehicle, the server 20 sets, as the assessed price for the vehicle 30, a price that is lower as the vehicle index Iv is smaller within a range below the average assessed price of the same-type vehicles. However, when the vehicle 30 is the point-addition vehicle, the server 20 may set, as the assessed price for the vehicle 30, a price higher than the average assessed price of the same-type vehicles just by a first predetermined price, and when the vehicle 30 is the point-deduction vehicle, the server 20 may set, as the assessed price for the vehicle 30, a price lower than the average assessed price of the same-type vehicles just by a second predetermined price.

In the vehicle assessment method in the embodiment, the server 20 sets the assessed price of the vehicle 30 based on the average assessed price of the same-type vehicles (the vehicles of the same vehicle type as the vehicle 30). However, instead of this, the server 20 may set the assessed price of the vehicle 30 based on the average assessed price of vehicles of the same vehicle type and the same model year, the same color, or the like as the vehicle 30.

In the vehicle assessment method in the embodiment, the server 20 causes the assessed price of the vehicle 30 to be displayed on the display of the navigation system 36 or the portable terminal 40. However, in addition to the assessed price of the vehicle 30, the server 20 may cause information used to set the assessed price to be displayed on the display of the navigation system 36 or the portable terminal 40. The information is, for example, a point-addition reason, a point-deduction reason, or the like that affects the setting of the vehicle index Iv used to determine which one of the average vehicle, the point-addition vehicle, and the point-deduction vehicle corresponds to the vehicle 30. Hereby, the user can also grasp the reason why the assessed price is set for the vehicle 30, in addition to the assessed price of the vehicle 30.

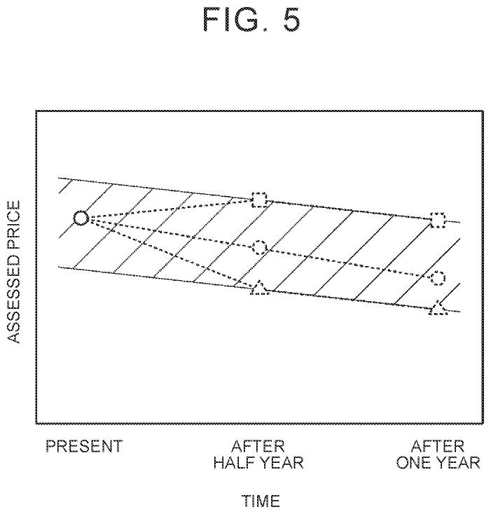

In the vehicle assessment method in the embodiment, the server 20 sets the assessed price of the vehicle 30 and causes the assessed price to be displayed on the display of the navigation system 36 or the portable terminal 40. However, in addition to the present assessed price of the vehicle 30, the server 20 may set present and future assessed price ranges and so on of the vehicle 30 and cause them to be displayed on the display of the navigation system 36 or the portable terminal 40. FIG. 5 is an explanatory view illustrating an example of the present assessed price of the vehicle 30, the present and future assessed price ranges, and so on. In the figure, a continuous circle mark indicates the present assessed price of the vehicle 30, a region with hatching indicates the present and future assessed price ranges of the vehicle 30, a dotted circle mark indicates an assessed price to be set when the usage of the vehicle 30 after half a year or a year is similar to that at present and the aging state of each part (e.g., the engine 31, the motor 32, and the driving power storage device 33) gets worse than the present aging state (the part deteriorates without being replaced), a dotted square mark indicates an assessed price (the upper limit of the assessed price range) to be set when the vehicle index Iv is maximum after half a year or a year, and a dotted triangular mark indicates an assessed price (the lower limit of the assessed price range) to be obtained when the vehicle index Iv is minimum after half a year or a year. The present assessed price range of the vehicle 30 can be set based on the number of vehicles per price range in terms of the same-type vehicles in the present distance range to which the vehicle 30 belongs. For example, in a case where the number of vehicles per price range in terms of the same-type vehicles in the present distance range to which the vehicle 30 belongs is the one illustrated in FIG. 4, the present assessed price range of the vehicle 30 can be set to the range from 100,000 yen to 2,890,000 yen. The future assessed price range (after half a year, after a year, or the like) of the vehicle 30 can be set such that a future travel distance is estimated based on the number of years and the travel distance to date from the manufacture of the vehicle, and the future assessed price range is be set based on the number of vehicles per price range in terms of the same-type vehicles in a future distance range to which the future travel distance of the vehicle 30 belongs. When the present and future assessed price ranges (see the hatching in FIG. 5) of the vehicle 30 and the future assessed prices (see the dotted circle marks, the dotted square marks, and the dotted triangular marks in FIG. 5) are displayed on the display of the navigation system 36 or the portable terminal 40, the user can consider the timing to replace the vehicle 30 with a new one. In a case where the navigation system 36 or the portable terminal 40 is operated by the user to transmit a replacement planned timing of the vehicle 30 to the server 20, the server 20 may acquire information on recommended vehicles including new and used vehicles that have suitable sales prices, suitable vehicle delivery timings, and the like from various websites and so on in consideration of the assessed price and the like of the vehicle 30 at the replacement timing of the vehicle 30, and the server 20 may cause the information on the recommended vehicles to be displayed on the navigation system 36 or the portable terminal 40.

In a case where the present and future assessed price ranges of the vehicle 30 or the future assessed prices of the vehicle 30 are displayed on the display of the navigation system 36 or the portable terminal 40, the server 20 may create advice information so that the future assessed price of the vehicle 30 approaches the upper limit of the assessed price range (close to the dotted square marks in FIG. 5), and the server 20 may cause the advice information to be displayed on the display of the navigation system 36 or the portable terminal 40. Further, regardless of whether or not the present and future assessed price ranges of the vehicle 30 or the future assessed prices of the vehicle 30 are displayed on the display of the navigation system 36 or the portable terminal 40, the server 20 may create advice information so that the vehicle 30 is maintained to be the point-addition vehicle in the future (in some embodiments, the vehicle index Iv increases more) or the vehicle 30 turns from the average vehicle or the point-deduction vehicle to the point-addition vehicle, and the server 20 may cause the advice information to be displayed on the display of the navigation system 36 or the portable terminal 40. Hereby, the user can consider the usage of the vehicle 30 or replacement of parts in order to restrain the assessed price of the vehicle 30 from decreasing (in order to improve the assessed price in some embodiments) or consider the timing to replace the vehicle 30 with a new one.

Here, the advice information can be information that helps the vehicle index Iv to increase. For example, the advice information can be recommendation of regular use of the vehicle 30 or recommendation of regular maintenance of the vehicle 30 in a regular dealer. Further, the advice information can be information to advise restraint of an operation by which the rotation number of the engine 31 becomes larger than a predetermined rotation number or the torque of the engine 31 becomes larger than a predetermined torque before the warming-up of the engine 31 is completed (e.g., restraint of large stepping of an accelerator pedal or the like). The advice information can be information to advise restraint of idling of the engine 31. The advice information can be information to advice restraint of an operation by which the absolute value of the acceleration of the vehicle 30 becomes larger than an acceleration threshold (e.g., restraint of large stepping of the accelerator pedal, large stepping of a brake pedal during traveling at a certain vehicle speed, or the like). The advice information can be information to advice restraint of stationary steering of the steering wheel of the vehicle 30 or restraint of parking of the vehicle 30 in sloped areas. The advice information can be information to advice restraint of the shift operation of the vehicle 30 in the direction reverse to its advancing direction or restraint of the shift operation of the vehicle 30 with the steering-wheel operation. The advice information can be also information to advice restraint of an operation by which the temperature of the driving power storage device 33 becomes higher than a predetermined temperature (e.g., large stepping of the accelerator pedal (because it is necessary to supply high electric power to the motor 32 from the driving power storage device 33 to drive the motor 32 by high torque)). The advice information can be information to advice replacement of a part (e.g., the engine 31, the motor 32, the driving power storage device 33, or the like) of the vehicle 30.

Note that, in a case where the user operates the navigation system 36 or the portable terminal 40 to request the server 20 to assess a replacement desirable part that is desired to be replaced in the vehicle 30, the server 20 may execute a part assessment program similar to the vehicle assessment program 22 (see FIG. 3) such that an assessed price is set for the replacement desirable part and displayed on the display of the navigation system 36 or the portable terminal 40. Hereby, the user can grasp the assessed price of the replacement desirable part, so that the user can consider the replacement of the replacement desirable part or the timing to replace the vehicle 30 with a new one.

In the embodiment, the server 20 executes the vehicle assessment method (the vehicle assessment program 22). However, instead of the server 20, a cloud system configured by using a cloud service provided by a cloud bender may execute the vehicle assessment method. Further, the vehicle 30 (e.g., the navigation system 36) or the portable terminal 40 may execute the vehicle assessment method. Further, a plurality of computers (e.g., respective computers as the navigation system 36 and the server 20) may separately execute corresponding processes of the vehicle assessment method.

Note that the correspondence between the main elements of the embodiment and the main elements of the disclosure described in the field of SUMMARY is one example for the embodiment to specifically describe the mode for carrying out the disclosure that is described in the field of SUMMARY, and therefore, the correspondence does not limit the elements of the disclosure described in the field of SUMMARY. That is, the disclosure described in the field of SUMMARY should be interpreted based on the description of the field, and the embodiment is just a concrete example of the disclosure described in the field of SUMMARY.

The mode for carrying out the present disclosure has been described above with reference to an embodiment. However, the present disclosure is not limited to such an embodiment at all, and it is needless to say that the present disclosure can be carried out in various forms within a range that does not deviate from the gist of the present disclosure.

The present disclosure is usable in an industry or the like related to vehicle assessment.

What it claimed is:

1. A vehicle assessment method for assessing a target vehicle, the vehicle assessment method comprising:
(A) a step of acquiring vehicle information on the target vehicle, the vehicle information including a travel distance of the target vehicle, and market information on resale prices or assessed prices of same-type vehicles as vehicles of the same vehicle type as the target vehicle;
(B) a step of determining, based on the vehicle information, which one of an average vehicle, a point-addition vehicle, and a point-deduction vehicle corresponds to the target vehicle and specifying, based on the market information on the same-type vehicles, an average assessed price of the same-type vehicles in a distance range to which the travel distance of the target vehicle belongs;
(C) a step of setting the average assessed price of the same-type vehicles as an assessed price for the target vehicle when the target vehicle is the average vehicle, setting a price higher than the average assessed price of the same-type vehicles as the assessed price for the target vehicle when the target vehicle is the point-addition vehicle, and setting a price lower than the average assessed price of the same-type vehicles as the assessed price for the target vehicle when the target vehicle is the point-deduction vehicle; and
(D) a step of outputting the assessed price of the target vehicle.

2. The vehicle assessment method according to claim 1, wherein, in the step (B), which one of the average vehicle, the point-addition vehicle, and the point-deduction vehicle corresponds to the target vehicle is determined based on at least one of a frequency of use of the target vehicle, a maintenance history of the target vehicle, an unwarmed operation state of an engine of the target vehicle, an idling time of the engine of the target vehicle, the number of times that an absolute value of acceleration of the target vehicle becomes larger than an acceleration threshold, the number of times of stationary steering of a steering wheel of the target vehicle, the number of times of parking of the target vehicle in sloped areas, the number of times of a shift operation of the target vehicle in a direction reverse to an advancing direction of the target vehicle, the number of times of the shift operation of the target vehicle with a steering-wheel operation, a use temperature history of a power storage device of the target vehicle, and an aging state of each part of the target vehicle.

3. The vehicle assessment method according to claim 1, wherein, in the step (A), upon receipt of a request of assessment of the target vehicle, the vehicle information on the target vehicle and the market information on the same-type vehicles are acquired.

4. The vehicle assessment method according to claim 1, further comprising (E) a step of, based on the market information, setting a future assessed price range of the target vehicle, wherein, in the step (D), in addition to the assessed price of the target vehicle, the future assessed price range and an upper limit of the future assessed price range are output, or the future assessed price range or the upper limit of the future assessed price range is output.

5. The vehicle assessment method according to claim 4, further comprising (F) a step of providing an advice such that a future assessed price of the target vehicle approaches the upper limit of the future assessed price range.

6. The vehicle assessment method according to claim 1, further comprising (F) a step of providing an advice such that the target vehicle is maintained to be the point-addition vehicle in future or the target vehicle turns from the average vehicle or the point-deduction vehicle to the point-addition vehicle.

7. A non-transitory storage medium storing a vehicle assessment program causing one or more computers to execute each of the steps of the vehicle assessment method according to claim 1.
